(19) United States
(12) Patent Application Publication
(10) Pub. No.: US 2004/0047471 A1
(43) Pub. Date: Mar. 11, 2004

(54) Monitoring computer

(76) Inventor: Tetsuya Sawano, Asaka-shi (JP)

Correspondence Address: BIRCH STEWART KOLASCH & BIRCH, PO BOX 747, FALLS CHURCH, VA, 22040-0747, US

(21) Appl. No.: 10/657,292

(22) Filed: Sep. 9, 2003

(30) Foreign Application Priority Data
Sep. 10, 2002 (JP) 2002-263483

(51) Int. Cl. H04K 1/00

(52) U.S. Cl. 380/250

(57) ABSTRACT

The image of an object to be monitored is captured periodically by a digital camera. A monitoring computer is accessed from a mobile telephone, whereupon still-image data representing the latest image captured by the digital camera is stored in the monitoring computer. The still-image data is subjected to a data conversion so as to be displayable by a display device of the mobile telephone. The still-image data that has undergone the data conversion is transmitted from the monitoring computer to the mobile telephone.

### BACKGROUND OF THE INVENTION

1. Field of the Invention

This invention relates to a computer for monitoring purposes, a method of controlling this computer and a program for controlling the computer.

2. Description of the Related Art

In a monitoring system known in the art, a digital camera or Web camera for monitoring purposes and a computer are connected together and an image captured by the digital camera is displayed on the display screen of a mobile telephone. In a monitoring system of this kind, image data representing the image captured by the digital camera is input to the computer. A user who wishes to view the image captured by the digital camera accesses the computer from the mobile telephone via a data center server. In response to a view request from the mobile telephone, the image data captured by the digital camera (Web camera) is transmitted to the mobile telephone via the data center server. The image captured by the digital camera is displayed on the display screen of the mobile telephone.

Thus, in this conventional monitoring system, a request to view an image is applied to the computer via the data center server, and transmission of image data also involves the application of image data from the computer to the mobile telephone via the data center server. This means that the data center server is accessed in concentrated fashion.

### SUMMARY OF THE INVENTION

Accordingly, an object of the present invention is to view a monitored image with a mobile telephone, which is equipped with a display device, without the intermediary of a data center server.

According to the present invention, the foregoing object is attained by providing a monitoring computer comprising: an imaging control unit (imaging control means) for controlling an image sensing device so as to sense the image of a monitored object periodically and output image data representing the image of the monitored object; a receiving circuit (receiving means) for receiving mobile-telephone model information and an image view request transmitted from a mobile telephone having a display device; a converting unit (converting means) for applying a data conversion to monitored-image data, which is output from the image sensing device when an image view request has been received by the receiving circuit, based upon the model information received by the receiving circuit in such a manner that an image represented by the monitored-image data can be displayed on the display device of the mobile telephone; and a transmitting circuit (transmitting means) for transmitting the monitored-image data, which has undergone the data conversion by the converting unit, to the mobile telephone.

The present invention provides also a control method suited to the above-described monitoring computer. Specifically, the present invention provides a method of controlling a monitoring computer, comprising the steps of: sensing the image of a monitored object periodically using an image sensing device and obtaining image data representing the image of the monitored object; receiving mobile-telephone model information and an image view request transmitted from a mobile telephone having a display device; applying a data conversion to monitored-image data, which is output from the image sensing device when an image view request has been received, based upon the received model information in such a manner that an image represented by the monitored-image data can be displayed on the display device of the mobile telephone; and transmitting the image data, which has undergone the data conversion, to the mobile telephone.

The present invention further provides a program for controlling a monitoring computer, and a recording medium on which this program has been stored.

In accordance with the present invention, the image of a monitored object is sensed periodically by an image sensing device and image data representing the monitored object is output.

When the user of a mobile telephone having a display device wishes to view the monitored object, information relating to the model of the mobile telephone and an image view request are transmitted from the mobile telephone to the computer.

Upon receiving the image view request, the monitoring computer applies a data conversion (a data format conversion, size conversion, aspect-ratio conversion, reduction in number of colors, tone correction, etc.) in such a manner that the image represented by the image data output from the image sensing device when the request is received can be displayed on the display screen of the display device on the mobile telephone. The image data that has undergone the conversion is transmitted from the computer to the mobile telephone. Thus a monitored image captured by the image sensing device is displayed on the display screen of the display device on the mobile telephone.

Since image data obtained by the sensing of an image is subjected to a data conversion in the computer in accordance with the model of the mobile telephone, a monitored image can be displayed on the display screen of the display device on the mobile telephone without a data conversion being carried out in a data center server. The monitored image captured by the image sensing device can be displayed on the display screen of the display unit on the mobile telephone without the intermediary of a data center server.

The converting unit includes an image memory for storing monitored-image data output from the image sensing device in response to receipt of an image view request by the receiving circuit. In this case the monitored-image data would be subjected to the data conversion so as to be displayable on the display device of the mobile telephone based upon the model information received by the receiving circuit.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating an overview of a monitoring system according to an embodiment of the present invention;

FIG. 2 is a flowchart illustrating monitoring preprocessing according to the embodiment;

FIG. 3 is a flowchart illustrating monitoring processing according to the embodiment; and

FIGS. 4 and 5 are diagrams illustrating examples of display screens on a mobile telephone according to the embodiment.

### DESCRIPTION OF THE PREFERRED EMBODIMENT

A preferred embodiment of the present invention will now be described in detail with reference to the accompanying drawings.

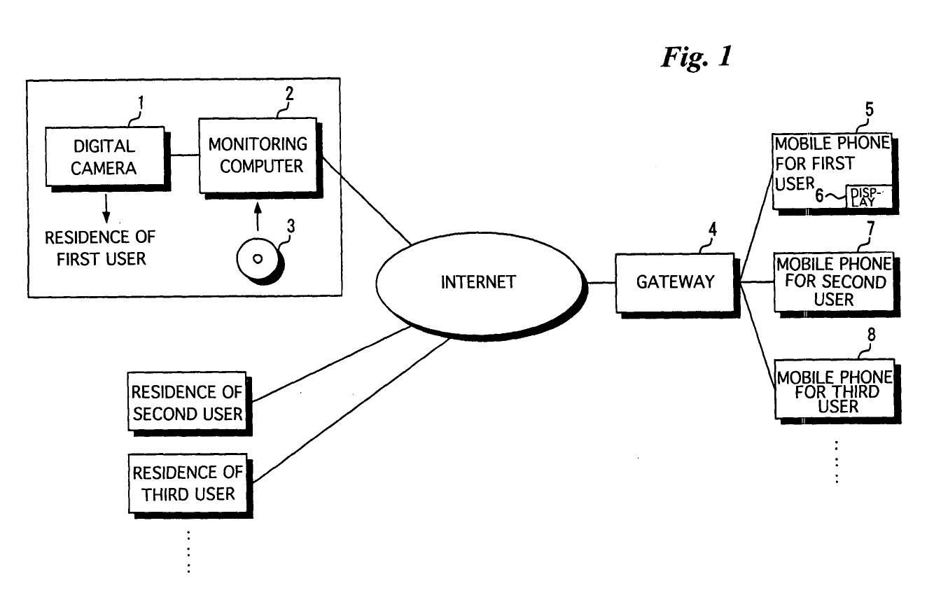

FIG. 1 is a diagram illustrating a monitoring system illustrative of an embodiment of the present invention.

As shown in FIG. 1, a digital camera 1 and a monitoring computer 2 connected to the digital camera 1 are installed at the residence of a first user. An operating program is installed in the monitoring computer 2 from a CD-ROM (Compact Disk—Read-Only Memory) 3 on which the program, which is for performing an operation (described later), has been stored. The sensing of an image by the digital camera 1 is controlled by the monitoring computer 2. An image of the situation (the monitored object) within the residence of the first user is sensed by the digital camera 1 periodically, i.e., at prescribed time intervals.

The monitoring computer 2 is connected to the Internet. It goes without saying that the monitoring computer 2 includes a communication circuit for accessing the Internet, an input unit such as a display device and keyboard, and an image memory for storing image data that is output from the digital camera 1.

Like the residence of the first user, a number of user residences such as residences of second and third users are connected to the Internet. In a manner similar to that of the first user residence, the second and third user residences also are provided with a digital camera and monitoring computer and each senses the image of a monitored object periodically by the digital camera.

A number of mobile telephones 5, 7, 8, . . . are connected to the Internet via a gateway 4. The mobile telephones 5, 7 and 8 are for use by the first, second and third users, respectively. The mobile telephone 5 includes a display device 6 having a display screen on which images and the like can be displayed. The mobile telephones 7 and 8 also include their own display devices. The monitoring computer 2 located at the residence of the first user can be accessed using the mobile telephone 5. Similarly, the monitoring computers located at the residences of the second and third users can be accessed using the mobile telephones 7 and 8.

The monitoring system according to this embodiment is such that viewing of a monitored image is requested by accessing the monitoring computer at the residence of each user using the mobile telephone without the intervention of a server. In response to the view request, data representing the monitored image captured by the digital camera is transmitted from the monitoring computer to the mobile telephone without using a server as an intermediary. Thus, a peer-to-peer monitoring system is realized. The details will become apparent from the description that follows.

In this embodiment, it will be assumed that an image captured by the digital camera 1 at the residence of the first user is viewed using the mobile telephone 5.

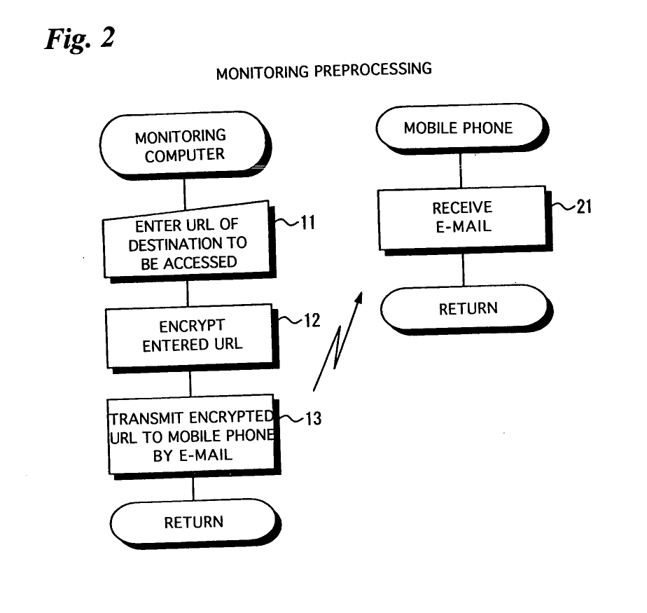

FIG. 2 is a flowchart illustrating monitoring preprocessing.

First, an URL (Uniform Resource Locator) for accessing the monitoring computer 2 by the mobile telephone 5 is entered at the monitoring computer 2 (step 11). The entered URL is encrypted by the monitoring computer 2 in such a manner that the related URL will not be readily inferred (step 12). Data representing the encrypted URL is transmitted as e-mail from the monitoring computer 2 to the mobile telephone 5 via the Internet and gateway 4 (step 13).

The e-mail that has been transmitted from the monitoring computer 2 is received by the mobile telephone 5 (step 21). The URL for accessing the monitoring computer 2 is displayed on the display screen of the display device 6 of the mobile telephone 5 in a clickable manner.

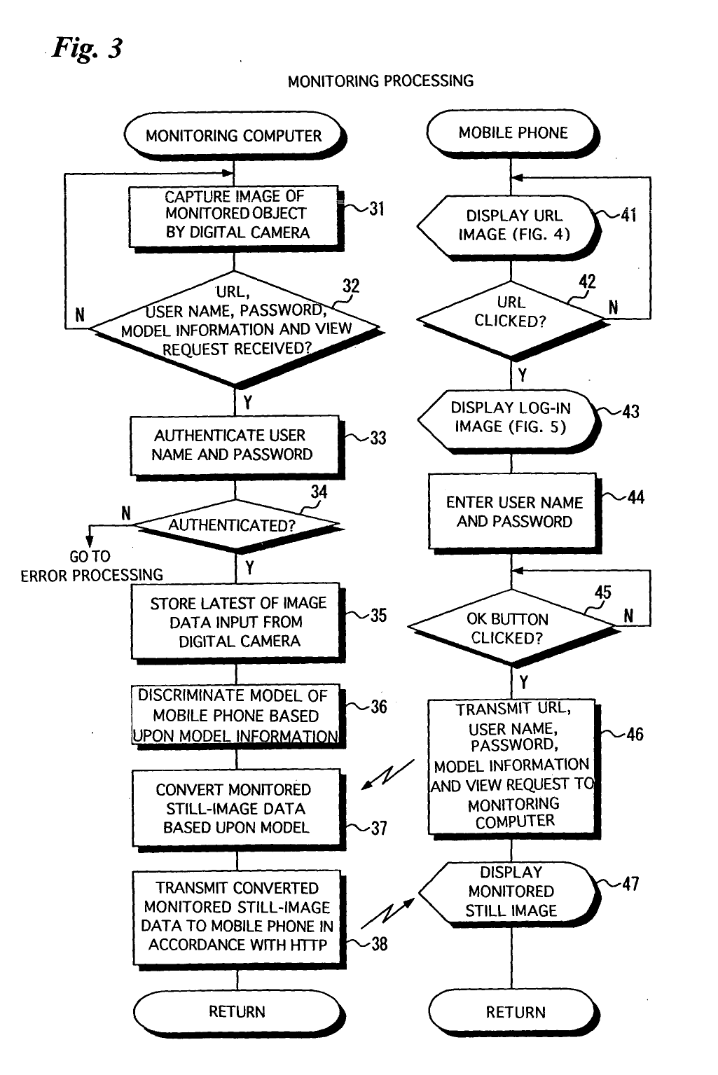

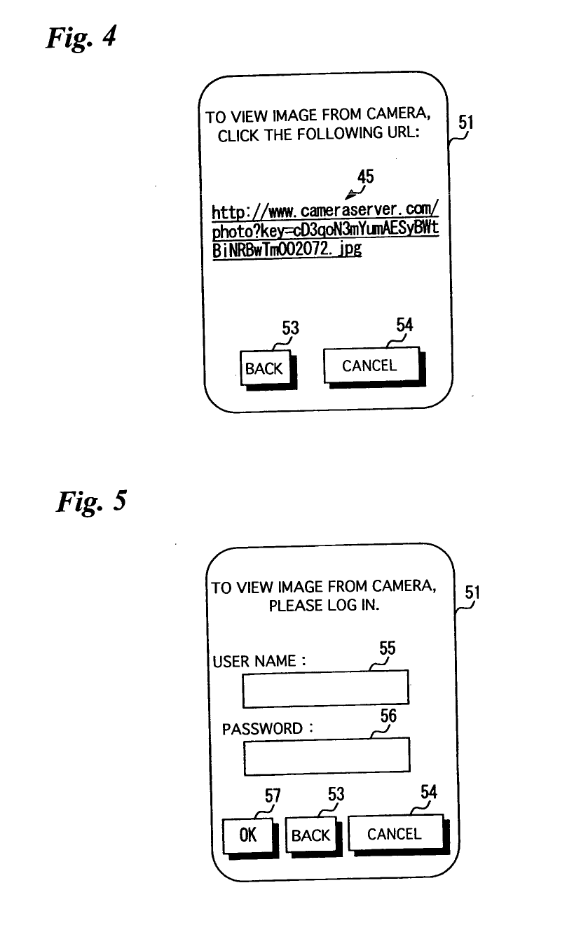

FIG. 3 is a flowchart illustrating monitoring processing, and FIGS. 4 and 5 show examples of display screens that appear on the display device 6 of the mobile telephone 5.

The image of the monitored object is captured by the digital camera under the control of the monitoring computer 2 (step 31). Image data representing the image of the monitored object is output from the digital camera 1 to the monitoring computer 2 based upon ftp (file transfer protocol). The image of the monitored object continues to be sensed by the digital camera 1 until a user name, password and view request, etc., are received from the mobile telephone 5 (“NO” at step 32).

An URL image that includes the URL transmitted from the monitoring computer 2 is displayed on a display screen 51 of the of the display device 6 on the mobile telephone 5 (step 41), as shown in FIG. 4.

The URL image displayed on the display screen 51 of the display device 6 includes an URL display area 52, as shown in FIG. 4. The clickable encrypted URL is displayed in the URL display area 52.

A BACK button and a CANCEL button are displayed below the URL display area 52 and are capable of being clicked as well.

With reference again to FIG. 3, a log-in image shown in FIG. 5 is displayed on the display screen 51 of the display device 6 on the mobile telephone 5 (step 43) if the URL being displayed on the display screen 51 is clicked by the user of the mobile telephone 5 (“YES” at step 42).

As shown in FIG. 5, the log-in image includes a user-name input are 55 and a password entry area 56. In addition to the RETURN button 53 and CANCEL button 54, an OK button 57 is formed below the areas 55 and 56.

The user name and password are entered using a numeric keypad on the mobile telephone 5 (step 44). It goes without saying that the user name and password are assigned to the user in advance. If the entered user name and password are correct, the OK button 57 is clicked by the user of the mobile telephone 5 (“YES” at step 45). If this is done, the URL, the entered user name and password, information regarding the model of the mobile telephone 5 and the view request are transmitted from the mobile telephone 5 to the monitoring computer 2 (step 46).

If the URL and the like transmitted from the mobile telephone 5 are received by the monitoring computer 2 (“YES” at step 32), a storage area of the memory in the monitoring computer 2 specified by the URL is accessed. The storage area of this memory is an area in which image data output from the digital camera 1 is stored in successive fashion temporarily.

Processing for authenticating the user name and password that have been transmitted from the mobile telephone 5 is executed by the monitoring computer 2 (step 33). If they are authenticated (“YES” at step 34), then the latest image data (image data representing the monitored still image) among the image data entered from the digital camera 1 is stored temporarily in the image memory of the monitoring computer 2 (step 35).

The model of the mobile telephone 5 is discriminated based upon the model information transmitted from the mobile telephone 5 (step 36). When the model of the mobile telephone 5 is discriminated, a data conversion is carried out in such a manner that the still image represented by the monitored still-image data is displayed on the display screen 51 of the display device 6 on the mobile telephone 5 (step 37). More specifically, a size adjustment conforming to the size of the display screen 51 of display device 6 is carried out and a format conversion, tone correction and adjustment of number of colors are executed so as to enable the image to be displayed on the display screen 51. It goes without saying that a table indicating what is to be converted for every model of mobile telephone has been stored in the monitoring computer 2.

The monitored still-image data that has undergone the data conversion is transmitted from the monitoring computer 2 to the mobile telephone 5 based upon http (hypertext transfer protocol) (step 38).

When the monitored still-image data transmitted from the monitoring computer 2 is received by the mobile telephone 5, the monitored still image is displayed on the display screen 51 of the display device 6 on the mobile telephone 5 (step 47).

Since a peer-to-peer monitoring system is constructed, it is unnecessary to provide a server between the monitoring computer and mobile telephone.

As many apparently widely different embodiments of the invention can be made without departing from the spirit and scope thereof, it is to be understood that the invention is not limited to the specific embodiments thereof except as defined in the appended claims.

What is claimed is:

1. A monitoring computer comprising:
an imaging control unit for controlling an image sensing device so as to sense the image of a monitored object periodically and output image data representing the image of the monitored object;
a receiving circuit for receiving mobile-telephone model information and an image view request transmitted from a mobile telephone having a display device;
a converting unit for applying a data conversion to monitored-image data, which is output from the image sensing device when an image view request has been received by said receiving circuit, based upon the model information received by said receiving circuit in such a manner that an image represented by the monitored-image data can be displayed on the display device of the mobile telephone; and
a transmitting circuit for transmitting the monitored-image data, which has undergone the data conversion by said converting unit, to the mobile telephone.

2. The computer according to claim 1, wherein said converting unit has an image memory for storing monitored-image data, which is output from the image sensing device, in response to receipt of an image view request by said receiving circuit;
the monitored-image data being subjected to the data conversion so as to be displayable on the display device of the mobile telephone based upon the model information received by said receiving circuit.

3. A method of controlling a monitoring computer, comprising the steps of:
sensing the image of a monitored object periodically using an image sensing device and obtaining image data representing the image of the monitored object;
receiving mobile-telephone model information and an image view request transmitted from a mobile telephone having a display device;
applying a data conversion to monitored-image data, which is output from the image sensing device when an image view request has been received, based upon the received model information in such a manner that an image represented by the monitored-image data can be displayed on the display device of the mobile telephone; and
transmitting the image data, which has undergone the data conversion, to the mobile telephone.

4. A program for controlling a monitoring computer so as to:
control an image sensing device so as to sense the image of a monitored object periodically and output image data representing the image of the monitored object;
receive mobile-telephone model information and an image view request transmitted from a mobile telephone having a display device;
apply a data conversion to monitored-image data, which is output from the image sensing device when an image view request has been received, based upon the received model information in such a manner that an image represented by the monitored-image data can be displayed on the display device of the mobile telephone; and
transmit the monitored-image data, which has undergone the data conversion, to the mobile telephone.

5. A recording medium storing the program set forth in claim 4.
